(19) United States
(12) Patent Application Publication
(10) Pub. No.: US 2006/0277142 A1
(43) Pub. Date: Dec. 7, 2006

(54) Monitoring system

(76) Inventor: Jeffrey Bruce McGeorge, Queensland (AU)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 10/561,494

(22) PCT Filed: Jun. 18, 2004
(86) PCT No.: PCT/AU04/00806

§ 371 Date: May 16, 2006

(30) Foreign Application Priority Data
Jun. 19, 2003 (AU) 2003100487

(51) Int. Cl. G06Q 40/00

(52) U.S. Cl. 705/39

(57) ABSTRACT

A method of monitoring changes in an information set of wagers placed on the outcome of a sporting contest, the method comprising the steps of: (a) a principal entering into an agreement with a service provider to provide real time activity monitoring service, (b) the service provider monitoring a predetermined information set using at least one computer, and (c) the service provider providing a real-time alert message to the principal via a remote communications device (RCD) when a change occurs.

### TECHNICAL FIELD

The present invention relates to a monitoring system which combines credit card activity monitoring and the field of information technology in mobile communications. The invention also relates to a monitoring system which combines activity monitoring and the field of information technology in mobile communications.

### BACKGROUND ART

Most organisations and individuals regularly use credit cards for obtaining goods and services.

Despite advancements in technologies and security systems in relation to cash or credit transactions, there remains a need for an economic means of detecting credit card fraud at the instance it is taking place.

In Australia alone, credit card fraud amounts to $140 million per annum causing a great deal of inconvenience to cardholders and financial institutions alike.

In Asia, it is reported that credit card fraud exceeds $1 billion per annum.

Most fraudulent transactions take place in the absence of the card where orders are placed for goods or services over the net or by telephone.

The majority of fraudulent transactions are for small amounts. However, accumulatively, losses are high with costs being passed onto cardholders in general through interest rates.

Whilst banks scan transaction patterns and will contact a cardholder when patterns are unduly changed and warn them that the line of credit will be cancelled if the cardholder does not contact them, this type of security can often back-fire particularly if the transactions are by the cardholder who may be on holiday and not able to respond to any bank communication.

Most cardholders are able to instruct the bank as to limits they wish to apply to their accounts and some customers are able to inform banks of their usage patterns to thus enhance security.

The gambling market is an economic system composed of sets of interacting agents. The generator mechanism consists of the totaliser, the different types of competitors and various probability measures. Such systems possess perpetual novelty since there are many possible configurations. The dynamics and regularities of the gambling market are, likely to display a mix of persistent, antipersistent and random behaviour. Each contest is a game with each competitor having a market price and a natural price that is set by agent demand. The market price is reflected in the totaliser odds, and is one measure of probability. Agents that participate in such contests seek to profit when there is equivalence between the expected outcome (market price) and the actual outcome (natural price). Agent interactions therefore assess risk and reward in order to participate in a contest-based economy. Since the market grows in size in the approach to each contest start, various probability values are continuously communicated throughout the market.

Racetrack betting and stock market investment share several properties in common. In both cases, future earnings are uncertain, there are a large number of participants, and extensive information is available concerning investment variables. Wagering on race outcome is commonly done through a totaliser system. The tote screen displays win and place dividends for each competitor in a given contest which reflect the public's odds preferences. Wagers for a particular set of competitors in a particular contest form the betting pool, from which the prize money is first deducted from each wager. Totaliser dividends are updated periodically, and in Australia show the return to Win and to Place for each competitor. Although the process of wagering by the public is a continuous event up until the contest starts, tote dividend changes occur at discrete intervals. Therefore, the tote display as a whole represents the closed set of discrete update events that reflect market opinion of each competitor's chances of winning or placing.

The totaliser sets prices for win or place for each competitor in a given contest. These prices or dividends fluctuate according to how confident the betting public (the market) perceives each competitor's probability of winning or placing. The tote is therefore a good example of an iterative feedback system, where information from the public is introduced at discrete steps in time. Such systems are called discrete dynamical systems. Although the way in which money is wagered on the outcome of a particular contest may appear frenzied and continuous, the important point is that the tote displays this information in discrete time steps. In Australia, totaliser information is presented in the form of dividends (for $1) to win or to place. In the lead-up to post time, it is common for the dividends to fluctuate, often with remarkably large swings. Predicting the outcome of such games for profit involves placing a bet on one or more competitors in advance.

Various rules are often suggested in order to maximise the potential gain or minimise the potential harm leading from placing wagers on competitors. Examples of these rules in the context of horse racing are as follows:
RULE NO 1—Bet within your comfort level—The lesson to be learned is only wager amounts that you are comfortable with. Never bet with money you cannot afford to lose.
RULE NO 2—There is always tomorrow.
RULE NO 3—Increase your bets when winning, decrease when losing.
RULE NO 4—Judge how you are doing and the success of a product over a long period. Keep records!
RULE NO 5—Go to the track or TAB prepared.
RULE NO 6—Stay away from short-priced favourites—betting on short-priced favourites to win is a waste of time and will lead you to the poor house.
RULE NO 7—Do not be a slave to one type of handicapping system or school of thought—to be a successful handicapper you must be able to be flexible in your thinking and be willing to adjust at any time. Speed figures, pace numbers, video comments, pedigree analysis, class ratings, etc. all have their place.
RULE NO 8—Wait until the last few minutes to bet—let plays come to you. Watch the tote board. Think out your wagering strategy. Watch the horses on the track.
RULE NO 9—Before you place that bet, ask yourself if it's a smart wager.
RULE NO 10—Don't listen to or believe in “inside information”.

It is often observed that last minute plunges on competitors in contests are made by principals. In these cases, historical information suggests that these principals have information that the average person is not aware of. The principals wagers are generally placed just prior to the close of wagers on that particular contest due to the principals not wanting to notify the masses or other principals of the nature of the information and thereby gain an advantage over them.

If the average principal were able to examine the wagering trends and particularly the statistics of last minute plunge betting, they may be able to profit from the extra information evidenced by plunge betting.

It is an object of the present invention to provide a security system which will reduce credit card fraud in particular frauds where the card is not present.

It may be an object of an aspect of the present invention to provide a method of monitoring changes in an information set, to limit the potential harm or to maximise the potential gain from changes in that information set.

Further objects and advantages of the present invention will become apparent from the ensuing description which is given by way of example.

According to an aspect of the present invention there is provided a method of monitoring and confirming credit card usage,.the method comprising the steps of:
(a) a credit card holder or principal entering into an agreement with a service provider to provide real time credit card activity monitoring service,
(b) the service provider monitoring credit card activity using at least one computer, and
(c) the service provider providing a real-time message to the cardholder via a remote communications device (RCD).

The remote communications device (RCD) can comprise the principal's fixed or mobile telephone, a personal computing device or a facsimile or pager of the principal. All of these devices and others which are not listed but are included as a remote communication device can generally have a software component.

Information relating to the use of an individual credit card forms a part of a data feed. When a card is used, the information relating to the transaction is transmitted to a central point, usually a credit agency or a bank. The information may then be stored in the bank or credit agency's database.

The cardholder can communicate to the principal the criteria upon which alerts are to be sent.

The cardholder's RCD software component can be used to send input commands to a software environment that is running on the network of computer systems of the service provider.

In response to the input command, the software environment sends a local input command to a software environment component that processes the commands which responds by issuing a local output command to a server infrastructure which in turn sends a remote output command to the cardholder's RCD.

In response to remote output commands, the RCD can cause an alert output to be issued or displayed on or to the RCD.

A plurality of integrated and related systems can be provided to achieve information transfer.

The systems and relationships for information transfer can be as follows:
(i) From an Internet software, WAP enabled phone or mobile input device.

The cardholder sends a message or command from a remote communications device, which is directed to the central data server but must generally pass through or be intercepted by a scanning system and/or a switching box. The switching box may form a part of the central data server network.

The message may contain data including information about how to set up the cardholder's watches, the type of activity to be monitored as well as information on regular patterns of use of the card, requests for specific data or login information.
(ii) The scanning system may generally receive all messages sent from any computer or device connected or connecting to the system.

The scanning system generally performs at least one but generally a set of security tests on the information requested or submitted to the central data server. These tests are generally called security protocols. If the information requested or submitted is within the ambit of the security protocols, the scanning system may grant access to a secure level (authorisation level 2) which prevents unauthorised manipulation of the data held or accessed by the central data server.

Once access to authorisation level 2 has been granted, the information may be directed to a switch box to be processed.

The function of the switch box can be to:
(1) find the least busy drone computer within a network to process a specific command or watch;
(2) route alerts to an SMS (short message service) server to be sent to cardholders' computers or mobile handsets;
(3) send requested information between drone computers.

The switch box may be the centre of the system. It generally allocates the workload for each of the drone computers within the central data server and is generally also responsible for the release of alert messages and exchange of information between elements of the system.
(iii) Drone computer systems as part of the network are each connected via a local area network using the TCP/IP protocol (internet protocol). The drones are directly connected to each other to form the network and/or the credit card agency data server and the bank data server. The drone computers may preferably have two main purposes; they are as follows:
   (1) to accept, process and return data which a cardholder has requested from the service, and
   (2) to repetitively calculate cardholder's requested “watch data” (an event set by the cardholder to trigger an alert which is sent to the cardholder's mobile or RCD).
(iv) Communication server software receives a message from a drone computer routed through the switch box.

Once the Communication server software receives the message, the Communication server finds the corresponding cardholder's data (i.e. phone number, name) and passes the message as well as the correct phone number to send the message, to an SMS communications device.
(v) An SMS communications device receives a message from the Communication server and broadcasts it to the remote communications device.

According to a second form of the present invention there is provided a method of monitoring changes in an information set, the method comprising the steps of.
(a) a principal entering into an agreement with a service provider to provide real time activity monitoring service,
(b) the service provider monitoring a predetermined information set using at least one computer, and
(c) the service provider providing a real-time message to the principal via a remote communications device (RCD).

According to a particularly preferred embodiment, the present invention may be used to monitor the statistics of wagers placed on one or more events with partially uncertain outcomes such as horse racing, sporting contests or the like. These events normally have historical information associated with the competitors taking part therein for example the horses and/or jockeys in horse racing and the historical performance of teams in team sporting contests.

Typically, the service provider may use a network of more than one computer to monitor the activity. The network as a whole may be termed a central data server and usually comprises a number of drone computers.

Information relating to the wagers placed on the event may form a part of a data feed. When a wager is placed, the information relating to the wager is transmitted to a central point, usually a Totaliser Agency Board (TAB) computer or computer network or database. The information may then be stored in the TAB database.

The remote communications device (RCD) can comprise the principal's fixed or mobile telephone, a personal computing device or a facsimile or pager of the principal. All of these devices and others which are not listed but are included as a remote communication devices can generally have a software component.

The principal can communicate to the service provider the criteria upon which alerts are to be sent. Typically, the principal may request that alerts be sent advising the principal of last minute betting plunges on competitors in particular competitions, particularly those in which the principal is interested in wagering on.

The principal's RCD software component can be used to send input commands to a software environment that is running on the network of computer systems of the service provider.

In response to the input command, the software environment sends a local input command to a software environment component that processes the commands which responds by issuing a local output command to a server infrastructure which in turn sends a remote output command to the principal's RCD.

In response to remote output commands the RCD can cause an alert output to be issued or displayed on or to the RCD.

A plurality of integrated and related systems can be provided to achieve information transfer.

The systems and relationships for information transfer can be as follows:
(i) From an Internet software, WAP enabled phone or mobile input device.

The principal sends a message or command from a remote communications device, which is directed to the central data server but must generally pass through or be intercepted by a scanning system and/or a switching box. The switching box may form a part of the central data server network.

The message may contain data including information about how to setup the principal's watches, the type of activity to be monitored as well as information on regular patterns wagering, requests for specific data or login information.
(ii) The scanning system may generally receive all messages sent from any computer or device connected or connecting to the system.

The scanning system generally performs at least one, but generally a set of, security tests on the information requested or submitted to the central data server. These tests are generally called security protocols. If the information requested or submitted is within the ambit of the security protocols, the scanning system may grant access to a secure level (authorisation level 2) which prevents unauthorised manipulation of the data held or accessed by the central data server.

Once access to authorisation level 2 has been granted, the information may be directed to a switch box to be processed.

The function of the switch box can be to:
(1) find the least busy drone computer within a network to process a specific command or watch;
(2) route alerts to an SMS (short message service) server to be sent to principals' computers or mobile handsets;
(3) send requested information between drone computers.

The switch box may be the centre of the system. It generally allocates the workload for each of the drone computers within the central data server and is generally also responsible for the release of alert messages and exchange of information between elements of the system.
(iii) Drone computer systems as part of the network are each connected via a local area network using the TCP/IP protocol (internet protocol). The drones are directly connected to each other to form the network and/or the TAB data server and the bank data server. The drone computers may preferably have two main purposes; they are as follows:
(1) to accept, process and return data which a principal has requested from the service, and
(2) to repetitively calculate principal's requested “watch data” (an event set by the principal to trigger an alert which is sent to the principal's mobile or RCD).
(iv) Communication server software receives a message from a drone computer routed through the switch box.

Once the Communication server software receives the message, the Communication server finds the corresponding principal's data (i.e. phone number, name) and passes the message as well as the correct phone number to send the message, to an SMS communications device.
(v) An SMS communications device receives a message from the Communication server and broadcasts it to the remote communications device.

In an alternative embodiment of the present invention one or more “history servers” can be added, the purpose of which is to provide data to any of the computers connected to the network.

The history server is in place so that it can act as a gateway to the data feed.

The history server scoops all of the data out of the data feed as it comes along, so that the data never needs to be requested from an outside source more than once. Once the data is collected from the data feed or from the TAB database, the history server may store the data in its own database to prevent the need to request the same information numerous times.

All servers connected to the network request their data from the history server.

The drones may be no longer directly connected to the data feed but instead may be connected to the switch box and request their data from the new history server through the switch box.

A central data storage may be created to house the databases created by the history server.

Each history server connected to the system can then use these databases (located on another computer) so that cohesion remains throughout the network.

### BRIEF DESCRIPTION OF THE DRAWINGS

Aspects of the present invention will now be described with reference to the accompanying drawings in which:

FIG. 1 is a schematic representation of the operation of a first aspect of the present invention.

FIG. 2 is a schematic representation of the operation of a second aspect of the present invention.

FIG. 3 is a schematic representation of the interaction between an internal server infrastructure according to a preferred aspect of the present invention.

### DETAILED DESCRIPTION OF THE PREFERRED EMBODIMENTS

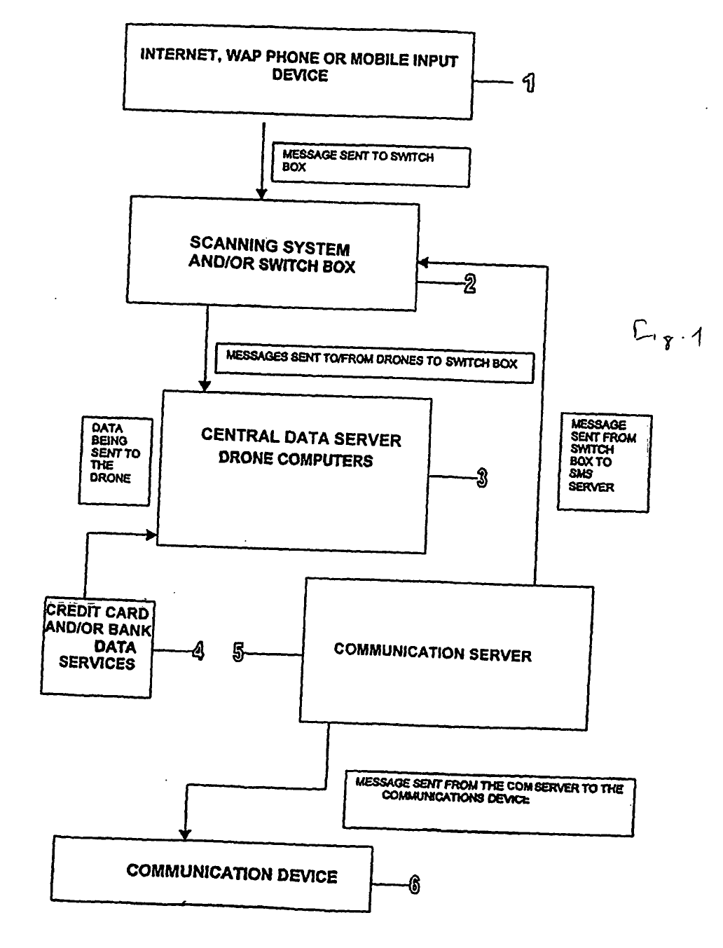

With respect to FIG. 1 of the drawings, element I sends a message directed to the central data server but the message is intercepted by the scanning system 2 and/or switch box. The message relates to the kind of data to view or what kind of indicators to add to a cardholder's usage patterns.

Element 2, the scanning system receives the message from the Internet, a WAP enabled phone or mobile input device. It then applies security protocols to the message to ascertain whether the information transmitted or requested is authorised information. If the security protocols are satisfied, the message passes to authorisation level 2 and is allowed to proceed.

The message proceeds to the switch box shown in the schematic illustrations as a part of the scanning system. The switch box then finds the least busy drone computer within the central data server network and sends the message to that computer to be processed.

The switch also processes logins and logoffs of the Communication server, drone computers and remote access.

Element 3 represents the central data server which is a series of computers connected via a network (LAN) which is also connected to the credit card agency data server, the bank data server and switch systems.

The drone processes messages from the cardholders (sent via the switch). These messages are requests to monitor usage patterns for irregularities. The drone computer then analyses the data available to it and applies the cardholder's chosen usage patterns, both past and present, to the data. If the data elicits a positive response (e.g. the current usage is irregular), the drone computer sends a message to the switch box which then sends it to the communication server.

Data from element 4 is fed from the credit card agency data server or bank data server to the drone computers (when requested to do so by the drone computer).

Element 5 receives a message from a drone computer which is routed through the switch box.

The message tells the communication server to find out what phone or remote communication device to send a message to.

The communication server then contacts the appropriate communications device and tells it to send the appropriate alert.

Element 6 receives the message from the communication server and broadcasts it to the remote communication device identification number sent to it from the communication server.

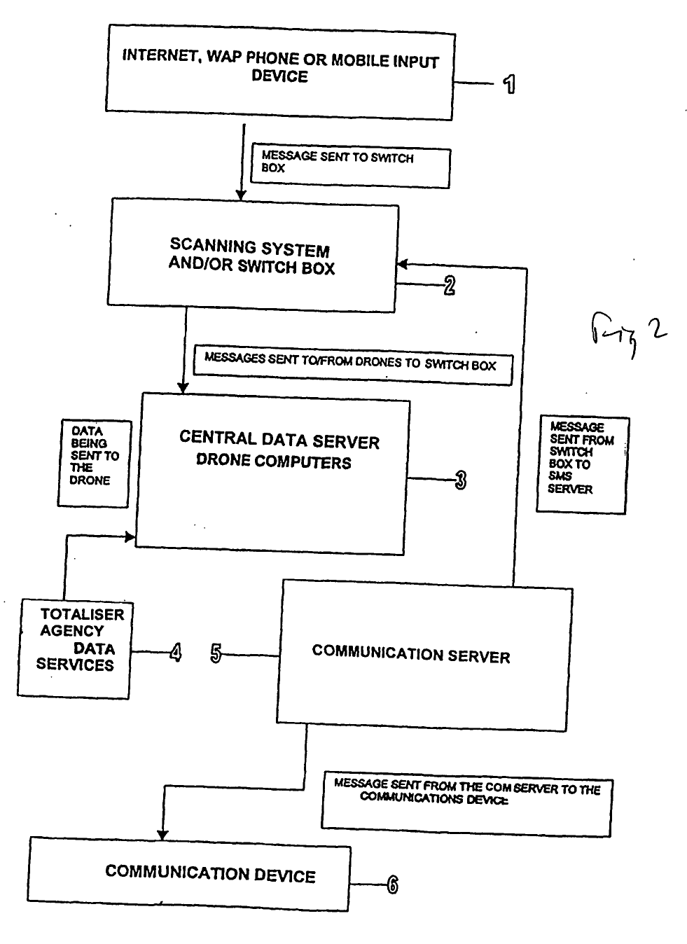

The main difference between the embodiment of the invention illustrated in FIGS. 1 and 2 is element 4 and the pool of data which the system is attached to and draws from. According to the system illustrated in FIG. 1, data from element 4 is fed from a credit card agency data server or bank data server whereas according to the system illustrated in FIG. 2, data from element 4 is fed from a totalisor agency data server to the drone computers (when requested to do so by the drone computer).

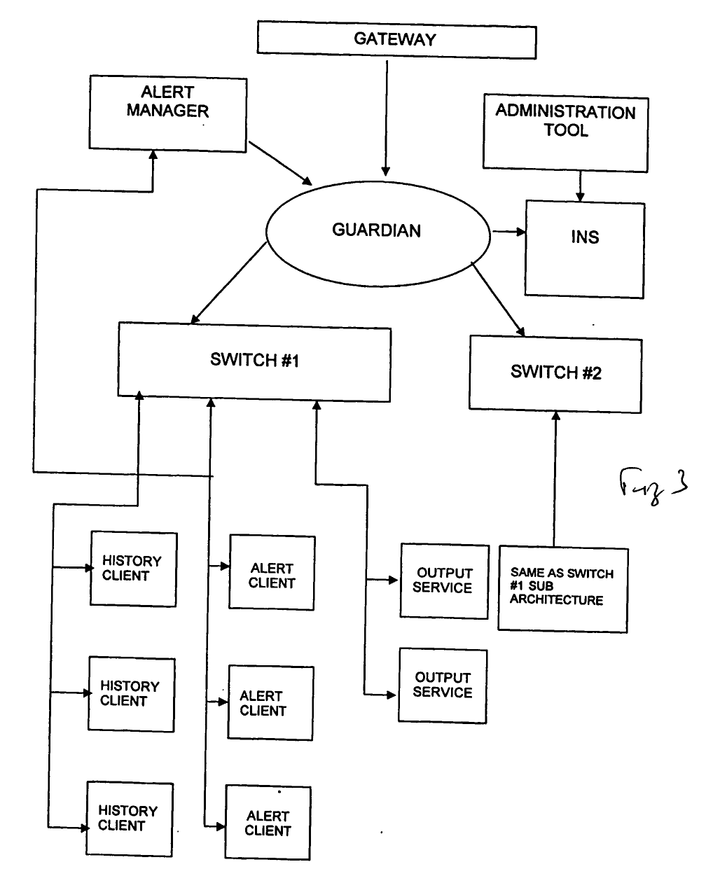

With respect to FIG. 3 of the drawings an internal server infrastructure can comprise the components illustrated and described below:

Gateway: The gateway is one of two parts directly connected to the Internet. It allows cardholders and network appliances to connect to their correct server.

Guardian: The guardian keeps track of all major servers on the network, major servers being single within the given locality. The guardian also has the ability to funnel small amounts of data from load management tools and administrator tools directly to the switchbox for routing and processing.

Alert Manager: The alert manager stores and distribute all created alerts to the least busy drone computer.

Administration tool: The administration tool allows a third party administrator to connect to the system and edit, remove or add cardholders without interrupting the flow of data around the rest of the system.

INS: The INS stores all of the cardholders details, including cardholder names, passwords and financial data. The INS is a request-only server from the service provider side of the network, and data inside it can only be changed from the administrator tool.

Switch: The switch server(s) is a routing device which routes information packets from one server to the other. Any switch's main job is keeping the network free from traffic bouncing between many erroneous servers before getting to its destination. Switchboxes are also used to apply “load balancing” to components of the network which are connected to it.

History Client: The history client(s) contain a large database of credit card usage data which is stored every time a transaction is made on the credit card. The history client is a request-only client which feeds data from itself to the requesting party, be it an internal server or external device.

Alert Client: The alert client(s) do all of the mathematical calculations for alerts currently running on the system. The alert client(s) request(s) data from the history client(s) and process(es) that data through a series of events. The alert client(s) is/are responsible for generating the final alert which is sent via the output service.

Output Service: The output service is the network connection software and hardware which connects the network of computers to an output device.

There are two major advantages of the present invention;
(1) Credit card usage analysis indicators can be applied to a cardholder's past or present usage data and boasts programming which can inform a cardholder of an “indicated” signal to do whatever the indicator was designed to inform the cardholder of, without the cardholder having to ponder over the data themselves.
(2) Credit Card usage analysis indicators can be set to “repeat” over a certain period and can be told to alert the cardholder when an “event” happens, via wireless or non-wireless technology wherever the cardholder may be.

The features of the system which result in the advantages mentioned above are as follows:
(1) The system is accessible and active at virtually all times, all day, everyday.
(2) The system can more quickly apply thousands of different or related parameters and/or specified patterns to credit card usage data.
(3) The system is more accurate and mathematical in its interpretation of results.
(4) The system can be designed to be “set” and “run” (e.g. the cardholder sets up their indicators and can be alerted of them until it is told to be stopped).

Aspects of the present invention have been described by way of example only and it will be appreciated that modifications and additions thereto may be made without departing from the scope thereof.

1. A method of monitoring changes in an information set of wagers placed on the outcome of a sporting contest, the method comprising the steps of:
a. a principal entering into an agreement with a service provider to provide real time activity monitoring service,
b. the service provider monitoring a predetermined information set using at least one computer, and
c. the service provider providing a real-time alert message to the principal via a remote communications device (RCD) when a change occurs.

2. A method as claimed in claim 1 wherein the service provider utilises a totalisor agency database to monitor the wagering activity.

3. A method as claimed in claim 1 wherein the remote communications device (RCD) comprises the cardholder's fixed or mobile telephone, a personal computing device or a facsimile or pager of the cardholder.

4. A method as claimed in claim 1 wherein the principal's RCD has a software component which can be used to send an input command to a software environment that is running on the network of computer systems of the service provider in response to the input command the software environment sends a local input command to a software environment component that processes the command and which responds by issuing a local output command to a server infrastructure which in turn sends a remote output command to the cardholder's RCD, and in response to a remote output commands, the RCD issues or displays an alert output.

5. A method as claimed in claim 1 wherein the principal can define parameters of a situation in which alert messages are to be issued.

6. A method as claimed in claim 1 wherein the service provider uses a network of computers or computer systems to monitor the credit card activity.

7. A method according to claim 5 wherein the network is adapted to send and receive information to and from a credit card agency data server and/or a bank data server, each of which contain real time information regarding the transactions of credit cards.

8. A method according to claim 1 further comprising the step of providing at least one history server, the purpose of which is to provide data to any of the computers, the history server scanning all of the transaction data as it becomes available so that the data never needs to be requested from an outside source more than once, the history server storing the data in a database to prevent the need to request the same information numerous times.

9. A method of monitoring and confirming credit card usage, the method comprising the steps of:
(a) a credit cardholder or principal entering into an agreement with a service provider to provide a real-time credit card transaction data monitoring service,
(b) the cardholder defining parameters for at least one predetermined anomalous situation,
(c) the service provider monitoring real-time credit card transaction data using at least one computer and comparing the data to the parameters set by the cardholder and
(d) the service provider providing a real-time alert message to the cardholder via a remote communications device (RCD) when the predetermined anomalous situation occurs.

10. A method as claimed in claim 8 wherein the cardholder communicates to the service provider at least one criteria upon which alerts are to be sent.
